(19) United States
(12) Patent Application Publication
(10) Pub. No.: US 2012/0297607 A1
(43) Pub. Date: Nov. 29, 2012

(54) COUPLING FOR VENTILATION ASSEMBLY

(75) Inventors: André PAQUET, Rouyn-Noranda (CA); Cristian Paquet, Rouyn-Noranda (CA)

(73) Assignee: MECHANICAD INC., Rouyn-Noranda (CA)

(21) Appl. No.: 13/307,542

(22) Filed: Nov. 30, 2011

Related U.S. Application Data
(60) Provisional application No. 61/418,067, filed on Nov. 30, 2010.

(51) Int. Cl. F16L 21/06; B23P 11/00

(52) U.S. Cl. 29/525.01; 285/400

(57) ABSTRACT

A coupling for a ventilation duct assembly for use with interconnecting ventilation duct elements and method of assembly is disclosed comprising a first and a second ventilation duct element formed from a flexible panel shaped and foldable into a ductwork element with a male end smaller in diameter than a female end and with an abutment for restricting movement of the female end over the male end of an adjacent ductwork element. A C-shaped collet is also provided and shaped to fit over the interconnecting male and female ends of the formed ductwork elements for interconnection of adjacent shaped ductwork elements, and sized to extend between adjacent slideable locking elements from corresponding adjacent shaped ductwork elements. A fastener fastens the collet around the shaped ductwork elements, and links extremities of the C-shaped collet together

### FIELD OF THE INVENTION

The present invention relates to ventilation ducts, and more particularly to a coupling for use with ventilation elements of a ventilation ductwork assembly.

### BACKGROUND OF THE INVENTION

This invention relates to a coupling for use with interconnecting ducts of a ventilation ductwork assembly in underground passages such as mines and tunnels.

There is presently a need for a coupling that is simple, efficient and compatible with interconnecting two ventilation ductwork elements made from foldable sheets.

### SUMMARY OF THE INVENTION

An object of the present invention is to provide a coupling for a ventilation ductwork assembly that satisfies the above mentioned need.

Accordingly, the present invention provides a coupling for a ventilation duct assembly for use with interconnecting ventilation duct elements comprising:
a first ventilation duct element comprised of a flexible panel wherein the flexible panel comprises:
   first and second opposite duct-forming sides;
   first and second opposite interconnecting sides for interconnection to a subsequent panel formed into a ductwork element; and
   a connector for connecting the duct-forming sides together upon shaping of the ductwork element and wherein the panel is shaped into a first ductwork element with a male end smaller in diameter than a female end;
a second ventilation duct element comprised of a flexible panel wherein the flexible panel comprises:
   first and second opposite duct-forming sides;
   first and second opposite interconnecting sides for interconnection to a subsequent panel formed into a ductwork element; and
   a connector for connecting the duct-forming sides together upon shaping of the ductwork element and wherein the panel is shaped into a second ductwork element with a male end smaller in diameter than the female end;
at least one C-shaped collet shaped to fit over the connected male and female ends of the formed ductwork elements for interconnection of adjacent shaped ductwork elements; and
at least one fastener for fastening the collet around the shaped ductwork elements, and linking extremities of the C-shaped collet together.

In addition to the above, the present invention also provides a C-shaped collet shaped to fit over connected male and female ends of formed ductwork elements for interconnection of adjacent shaped ductwork elements, the C-shaped collet comprising:
a collet strip;
first and second opposite brackets at opposite extremities of the collet strip,
at least one fastener for fastening the first and second opposite brackets together and maintaining an offset separation therebetween.

According to the present invention, there is also provided a method for assembling interconnecting ventilation ducts comprising the steps of:
a) inserting a female end of a formed ductwork element over a male end of an adjacent formed ductwork element;
b) inserting a C-shaped collet over the connected male and female ends of the formed ductwork elements, the C-shaped collet comprising:
   a collet strip; and
   first and second opposite brackets at opposite extremities of the collet strip,
and
   c) fastening the first and second opposite brackets together and maintaining an offset separation therebetween, with at least one fastener.

The coupling does not require that the brackets meet each other and that the collet encircles completely the ductwork element, which can represent material savings, in terms of the reduced lengths of collets to be manufactured, and add flexibility to the installation of the collet.

### BRIEF DESCRIPTION OF THE DRAWINGS

These and other objects and advantages of the invention will become apparent upon reading the detailed description and upon referring to the drawings in which:

FIG. 1A is a side view of a coupling for a ventilation ductwork assembly, according to a preferred embodiment of the present invention.

FIG. 1B is a perspective view of the coupling shown in FIG. 1A.

FIG. 1C is a top view of the coupling shown in FIG. 1A.

FIG. 1D is a detailed side view of interconnecting sides of the ventilation ductwork elements, before installation of the collet, according to a preferred embodiment of the present invention.

FIG. 1E is a detailed side view of interconnecting sides of the ventilation ductwork elements, after installation of the collet and fasteners, according to a preferred embodiment of the present invention.

FIG. 2 is a detailed perspective view of the ventilation ductwork element and collet of FIG. 1E, according to a preferred embodiment of the present invention where the fasteners comprise a plurality of brackets.

FIG. 3 is a detailed perspective view of the collet of FIG. 2.

FIG. 4 is a perspective view of a pallet supporting a plurality of stacked flat flexible panels for a ventilation duct assembly kit according to a preferred embodiment of the present invention;

FIGS. 5A and 5B are perspective and detailed views respectively of a shaped ductwork element and the associated interface between the assembled male and female interlocking interfaces according to a preferred embodiment of the present invention;

FIGS. 6A to 6C are perspective views illustrating a sealing step of the assembled male and female interlocking interfaces according to a preferred embodiment of the present invention;

FIG. 7 is a perspective view of a slideable locking element according to a preferred embodiment of the present invention;

FIG. 8 is a perspective views illustrating a sealing operation of an extremity of the slideable locking element shown in FIG. 4;

FIGS. 9A and 9B are a perspective views illustrating a sealing operation of the collets to be used in the kit according to a preferred embodiment of the present invention;

FIGS. 10A and 10B are a perspective views illustrating a fastening operation of the collets to the ductwork elements according to a preferred embodiment of the present invention;

FIGS. 11A and 11B are perspective views showing assembled ductwork elements installed for use in a tunnel according to a preferred embodiment of the present invention.

### DETAILED DESCRIPTION OF PREFERRED EMBODIMENTS

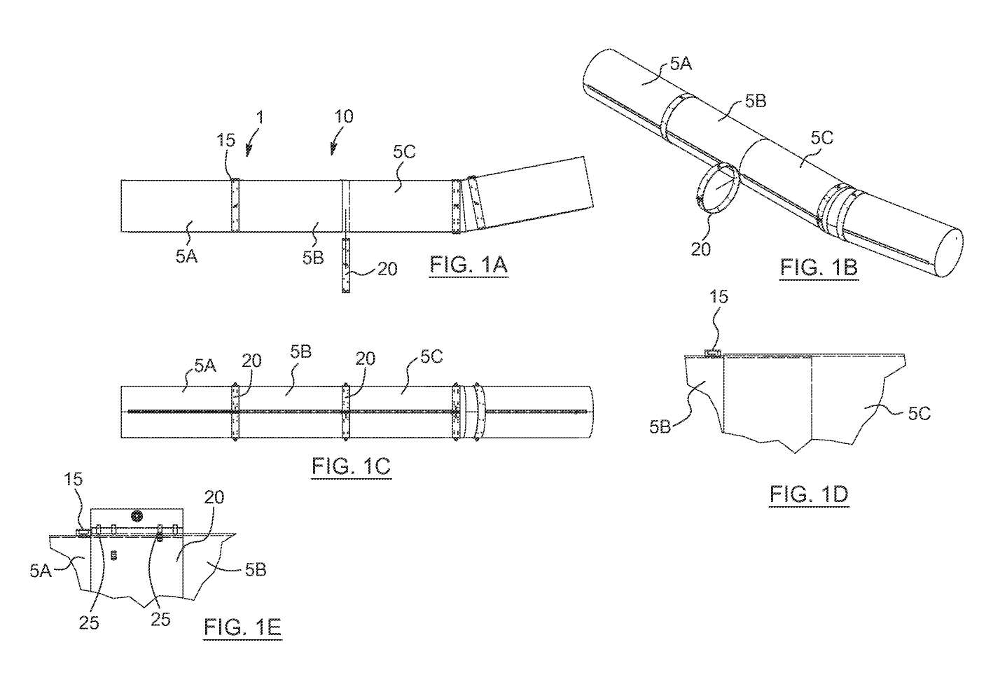

As shown in FIG. 1A, the present invention provides a coupling (1) for a ventilation duct assembly (10) for use with interconnecting ventilation duct elements (5). This coupling comprises a first ventilation ductwork element (5A) comprised of a flexible panel wherein the flexible panel has first and second opposite duct-forming sides, first and second opposite interconnecting sides for interconnection to a subsequent panel formed into a ductwork element (5A).

The flexible panel can be folded to form the ductwork element (5) through use of a male interlocking interface and a corresponding female interlocking interface of a fastening system that is respectively fixed on the first and second opposite duct-forming sides. This fastening system is used for interlocking the duct-forming sides together when shaping of the ductwork element.

The panel is shaped into a first truncated conical ductwork element with a male end that is smaller in diameter than an opposite female end. As it can be seen in FIGS. 1A 1D and 1E, an abutment (15) is found on the panel and on the formed ductwork element for restricting movement of the female end over the male end of an adjacent ductwork element, when inserted to form an interconnected ductwork assembly.

As shown in FIGS. 1A to 1C, the present invention also involves a second ventilation duct element (5B) comprised of a flexible panel wherein the flexible panel has first and second opposite duct-forming sides, such that, when folded, they form a second ductwork element. The panel also has first and second opposite interconnecting sides so that the folded panel can interconnect to a subsequent panel formed into a ductwork element.

A male interlocking interface and a corresponding female interlocking interface of a fastening system respectively fixed on the first and second opposite duct-forming sides of this panel are used for interlocking of the duct-forming sides together upon shaping of the ductwork element when the panel is shaped into a second truncated conical ductwork element with a male end smaller in diameter than the female end. However, the ductwork element may be formed through other means, including the use of adhesives or welding, without using interlocking interfaces.

This panel also has an abutment (15) for restricting movement of the female end over the male end of an adjacent duct element.

As shown in FIG. 1B, once a first ductwork element is interconnected with a second ductwork element, at least one collet (20) shaped to fit over the interconnecting male and female ends of the formed ductwork elements is placed to interconnect adjacent shaped ductwork elements (5A) and (5B), or (5B) and (5C). It is to be appreciated that a person versed in the art would understand that this collet (20) is adaptable to the various sizes of the formed ductwork elements and to the various conditions in which this collet is to be used.

As such and as shown in FIGS. 1B and 1C, this collet (20) is sized to extend between adjacent slideable locking elements from corresponding adjacent shaped ductwork elements.

As shown in FIG. 1E, a plurality of fasteners may be used for directly fastening the collet (20) to the shaped ductwork elements (5A), (5B). A person versed in the art would appreciate that these fasteners are not limited to one type and are adaptable to the specifications of the collet in question.

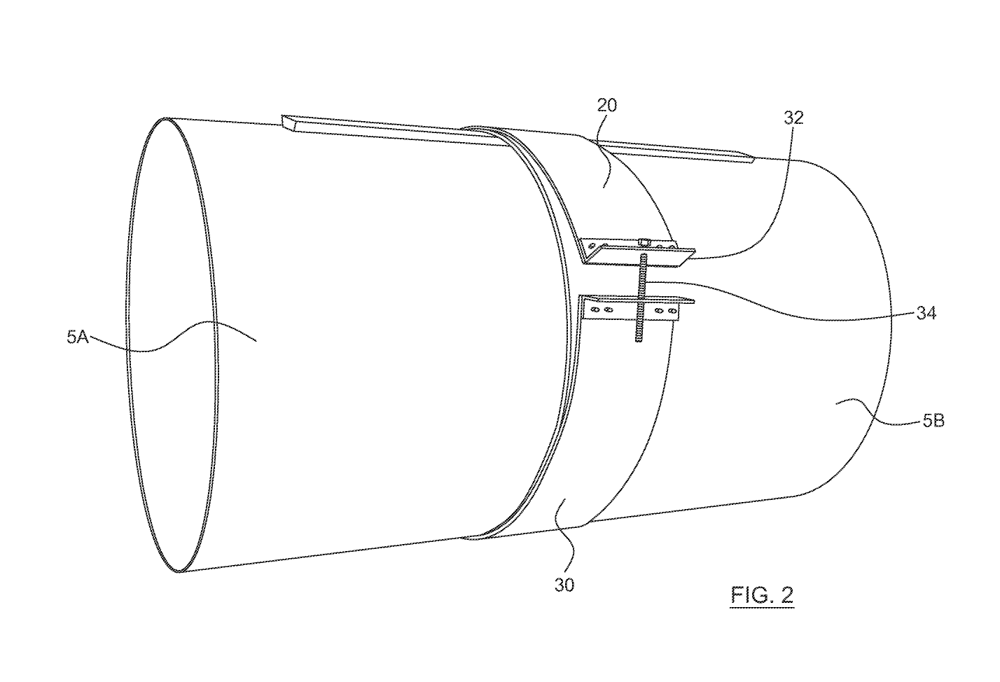

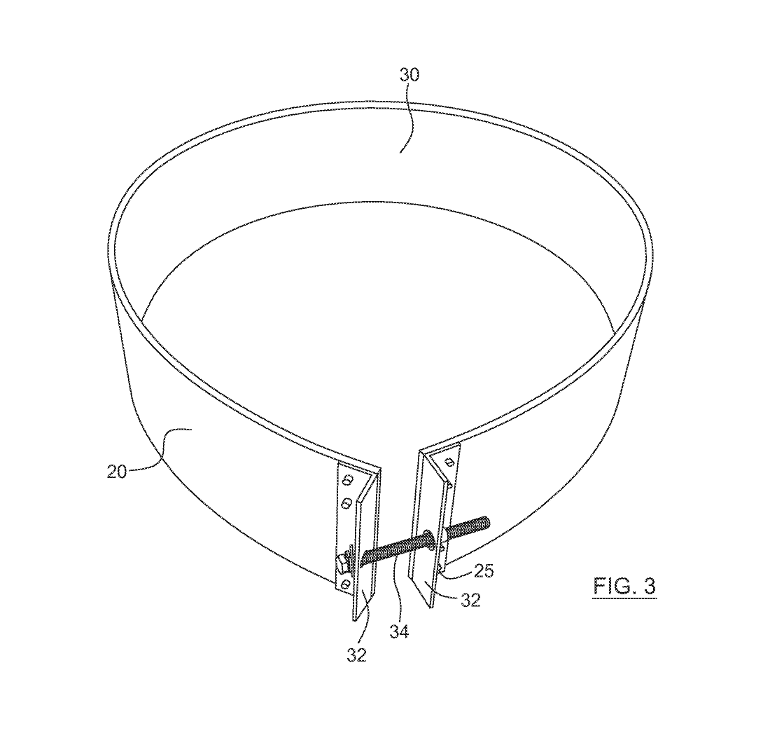

As shown in FIGS. 2 and 3, and according to a preferred embodiment of the present invention, the collet is a C-shaped collet having a collet strip 30 and a plurality of brackets 32 wherein at least one bracket is installed on each end of the collet strip. The brackets are fastened to the collet strip with any appropriate fastener or adhesive element. When both ends of the collet are placed together, the brackets of each end are in close proximity to one another and can be fastened together by bracket fasteners 34, such as a screw or a bolt. As shown in FIGS. 2 and 3, the collet may be made with a material similar to that used for the ductwork elements. The bracket fastener is chosen to accommodate different offset separation spacings between the end brackets of the collets such that fastening of one bracket end to another does not require that the brackets meet each other and that the collet encircles completely the ductwork element, which can represent material savings, and add flexibility to the installation of the collet.

In addition to the above, the present invention also provides a method for assembling interconnecting ventilation ducts according to above. This method involves the steps of:
a) inserting a female end of a formed ductwork element over a male end of an adjacent formed ductwork element until it reaches an abutment;
b) inserting the collet over the overlapping male and female ends of the interconnected adjacent ductwork elements between the respective slideable locking elements of the interconnected adjacent ductwork elements; and
c) fastening the collet to the adjacent formed ductwork elements with the fasteners.

According to the present invention, there is also provided a method for assembling interconnecting ventilation ducts comprising the steps of:
a) inserting a female end of a formed ductwork element over a male end of an adjacent formed ductwork element;
b) inserting a C-shaped collet shaped to fit over the connected male and female ends of the formed ductwork elements, the C-shaped collet comprising:
   a collet strip; and
   first and second opposite brackets at opposite extremities of the collet strip,
and
   c) fastening the first and second opposite brackets together and maintaining an offset separation therebetween, with at least one fastener.

The following sections give an example of how the ductwork elements can be formed in general, according to a preferred embodiment of the present invention.

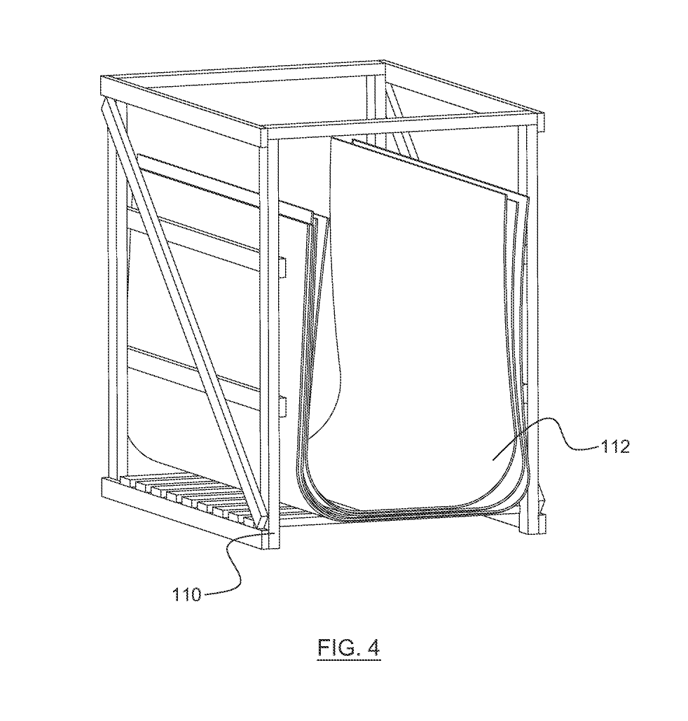

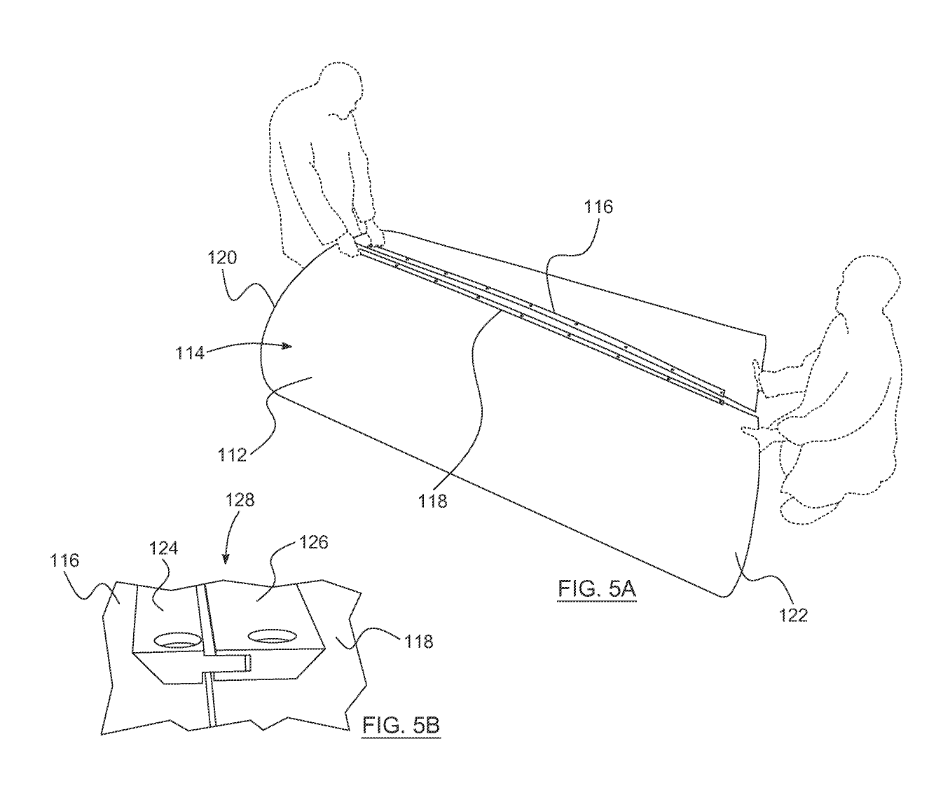

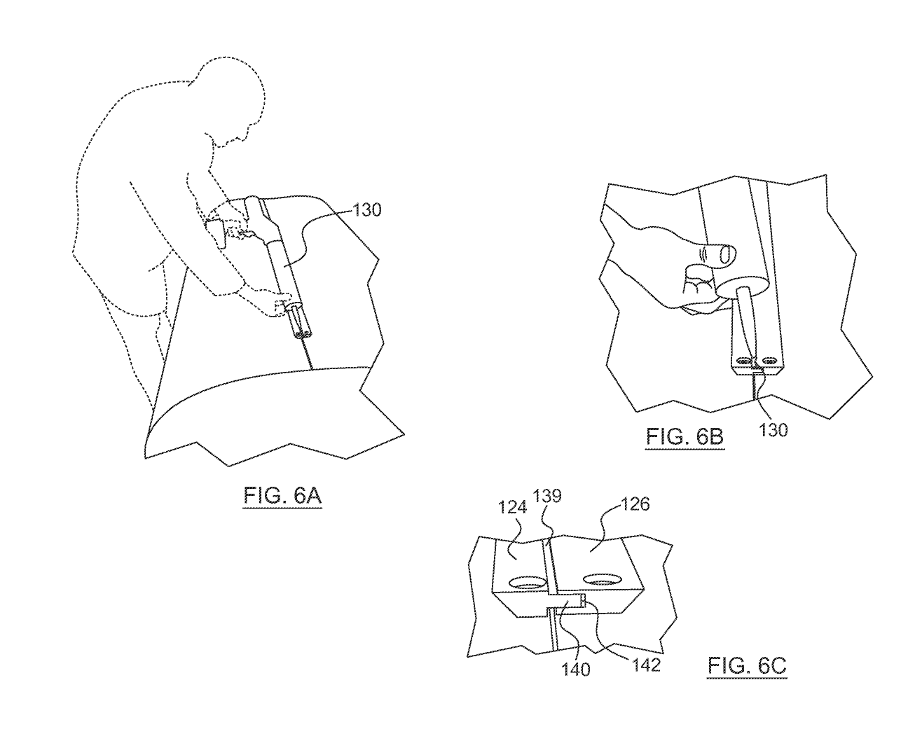

As shown in FIGS. 4 to 11B, the present invention provides a ventilation duct assembly kit for use for forming interconnecting ventilation ducts. The kit comprises, as shown in FIG. 4, a pallet 110 supporting a plurality of stacked flat flexible panels 112 that are shapeable into ductwork elements 114. As better shown in FIG. 5A, each of said flexible panels 112 comprises first and second opposite duct-forming sides 116,118, as well as first and second opposite interconnecting sides 120,122, for interconnection to a subsequent panel formed into a ductwork element. As better shown in FIG. 5B, the panel 112 also comprises a male interlocking interface 124 and a corresponding female interlocking interface 126 of a fastening system 128 respectively fixed on the first and second opposite 116,118 duct-forming sides for interlocking of the duct-forming sides 116,118 together upon shaping of the ductwork element. As better shown in FIGS. 6A to 6C, the kit also includes sealant 130 for sealing of the male 124 and female 126 interlocking interfaces after shaping of the ductwork element.

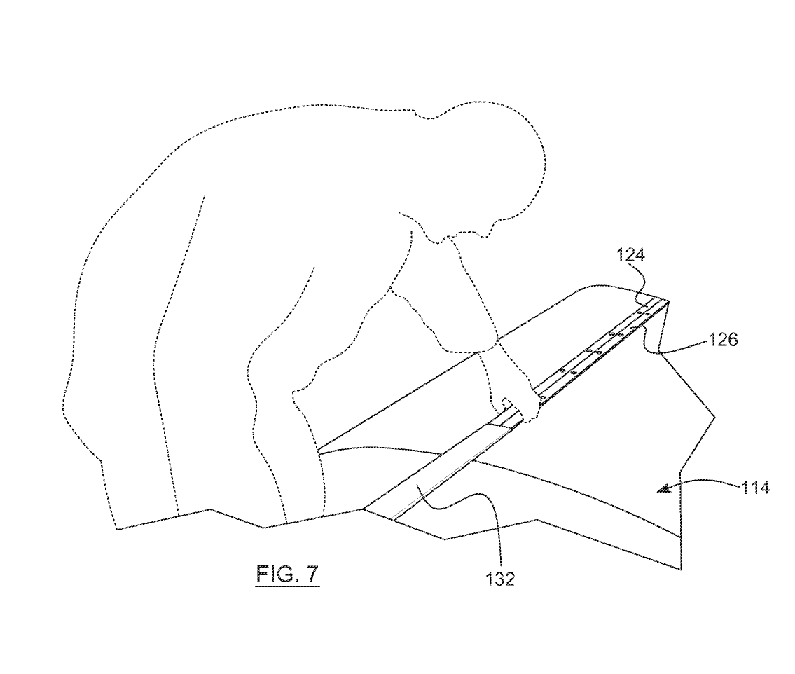

As better shown in FIG. 7, the kit also includes a plurality of slideable locking elements 132 shaped to slide and fit over assembled male and female interlocking interfaces 124,126 after shaping of the ductwork element 114.

Preferably, the kit also includes a plurality of collets 134 shaped to fit over the interconnecting sides 120,122 of the formed ductwork elements 114 for interconnection of adjacent shaped ductwork elements 114. The collets 134 are sized to extend between the adjacent slideable locking elements 132 from corresponding adjacent shaped ductwork elements 114. The kit also includes a plurality of fasteners 134 for fastening the collets 132 to the shaped ductwork elements 114.

Preferably, as shown in FIG. 5B, the male interlocking interface 124 and a corresponding female interlocking interface 126, when assembled, form a generally trapezoidal structure with an even top surface 139. Thus the slideable locking elements 132 are shaped to fit and slide over this trapezoidal profile and top surface 139. Moreover, the male interlocking interface 124 preferably comprises a projection 140, shaped to fit in a corresponding groove 142 in the female interlocking interface 126.

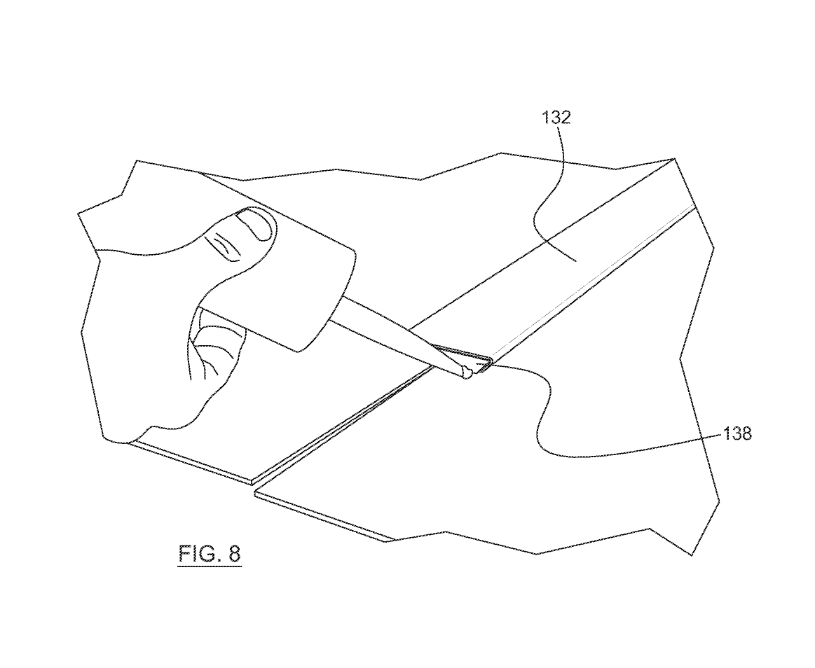

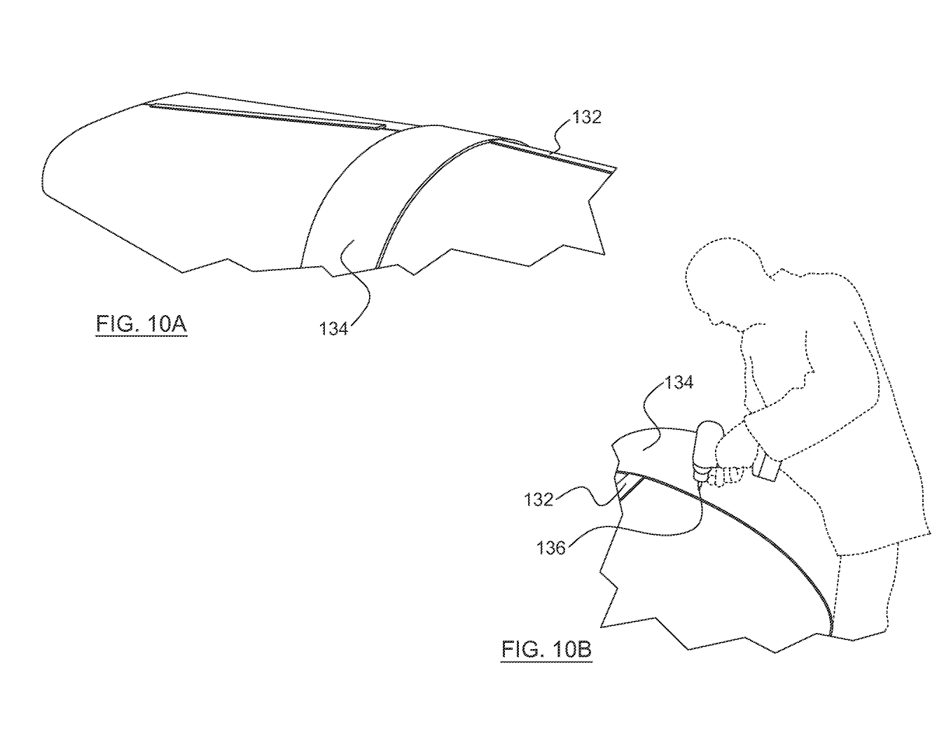

The present invention also provides a method for assembling interconnecting ventilation ducts, the method comprising the steps of:
a) providing a ventilation duct assembly kit, as described above;
b) taking a flat flexible panel 112 and, as better shown in FIGS. 5A and 5B, placing the male interlocking interface 124 of said panel into the corresponding female interlocking interface 126 to form a ductwork element 114;
c) as better shown in FIGS. 6A to 6C, sealing an interface 136 between the assembled male interlocking interface 124 and the corresponding female interlocking interface 126 with the sealant 130;
d) as better shown in FIG. 7, sliding a slideable locking element 132 over the assembled male and female interlocking interfaces 124,126;
e) as better shown in FIG. 8, sealing the extremities 138 of the slideable locking elements 132 placed over the assembled male and female interlocking interfaces 124,126 with the sealant 130;
f) as better shown in FIG. 10A, inserting a collet 134 over an interconnecting side of the formed ductwork element 114 until it contacts the slideable locking element 132;
g) inserting the collet 134 over an interconnecting side of an adjacent formed ductwork element 114 until it contacts the slideable locking element 132 of said adjacent formed ductwork element to interconnect the adjacent formed ductwork elements; and
h) as better shown in FIG. 10B, fastening the collet 134 to the adjacent formed ductwork elements 114 with fasteners 136.

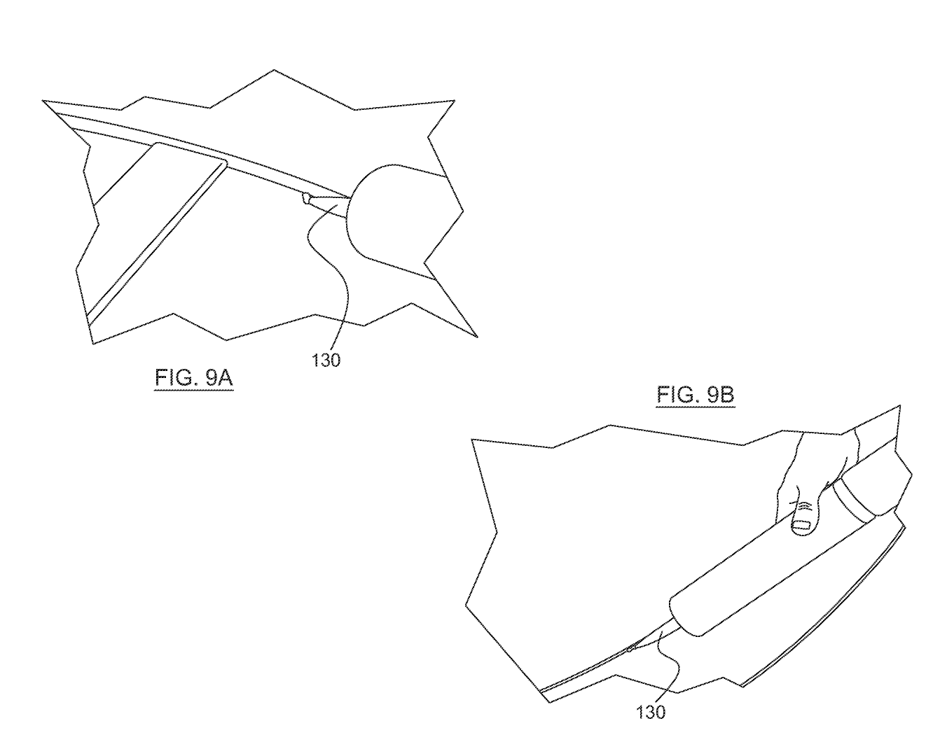

Preferably, as better shown in FIGS. 9A and 9B, before steps f) and g), sealant 130 is applied to the interconnecting sides of the formed ductwork elements 114 to properly seal the joint.

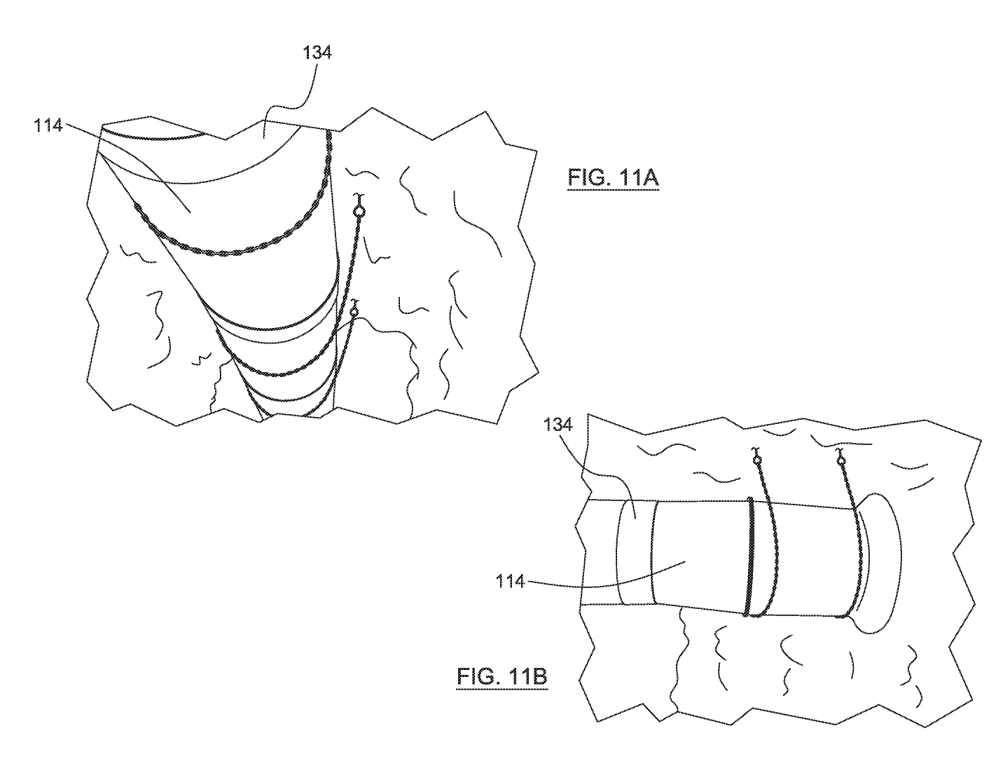

FIGS. 11A and 11B show the assembled ductwork elements installed for use in a tunnel.

The ventilation system made from the kit is preferably built in a factory or on site by specialized technicians. The ventilation system uses ducts made of products produced by Quadrant EPP such as HDPE (for the more-rigid interlocking interfaces) and copolymers (for the flexible panels), or other appropriate plastic materiaks. Such materials are chosen for their low friction coefficients, their great flexibility as well as their light weight depending on the application.

The ducts are developed with high performance equipment and tooling. The modern method of installing the ventilation system respects the capacity of the equipment on which the system is built-on. Required support equipment includes joining tools, numerical milling machines and manual extruders.

The following table shows results obtained with rigid ventilation ducts with slideable locking elements:

| | October 20 | October 29 | November 3 | November 10 | November 24 |
|---|---|---|---|---|---|
| Beginning of ramp | 89485 CFM | 80216 CFM | 81687 CFM | 84358 CFM | 81694 CFM |
| After 178 m | 90860 CFM | 81420 CFM | 77880 CFM | 81892 CFM | 86544 CFM |
| After 250 m | 78771 CFM | 70091 CFM | 65751 CFM | 67704 CFM | 72261 CFM |
| After 333 m | — | — | 62985 CFM | 64753 CFM | 66963 CFM |
| After 411 m | — | — | — | — | 64170 CFM |
| Advancement | — | — | — | 437 m | 471 m |
| (gallery in meters) | | | | | |
| Static pressure (in psi) | 6.45 | 6.45 | 6.45 | — | 5.97 |

Note:
Results obtained with an L-shaped gallery measuring 4.3 m × 4.2 m.

### Steps in Assembly of Duct

The text below provides further descriptions of the method for assembly of the interconnecting ducts according to a preferred embodiment of the present invention.

The first step, shown in FIGS. 5A and 5B, consists in assembling two separate parts of a panel 112 together. The male mounting element of the interlocking interface 124 is inserted in a groove 146 up to the bottom thereof (of the female interlocking interface 126).

Then, in step 2 shown in FIGS. 6A to 6C, a thin line of sealing material or caulking 130 (of the type Zip & Seal™) is spread on the middle of the male mounting element groove interface 139.

At step 3 shown in FIG. 7, a metallic slideable locking element 132 is slid on the interface assembly at one of the extremities thereof and another slideable locking element 132 is placed at the other extremity.

At step 4 shown in FIG. 8, a line of silicone or sealant 130 is then placed at both extremities of the slideable locking element 132.

At step 5 shown in FIG. 10A, a junction collet 134 is then inserted over the interface assembly until the collet 134 rests against slideable locking elements 132.

In step 6 shown in FIGS. 9A and 9B, in order to provide a quality seal to the joints of the ducts, lines of silicone or sealant 130 are placed on the inner side and outer side of the ductwork elements.

In step 7 shown in FIG. 10B, fasteners 136, such as support screws, are installed on the two collets 134 (preferably 8 to 10 screws per collet).

The above-mentioned assembly steps are repeated as required to form a length of the duct to be built.

In step 8 shown in FIGS. 11A and 11B, the assembled ductwork elements 14 can then be installed in a gallery or tunnel.

The ventilation ducts built from the kit according to the method of the present invention offers the following advantages:
ease of assembly
occupies very little space when descending underground (up to 30 ducts per pallet may be transported)
very low friction coefficient (K factor)
offers important energy savings
very competitive price.

Tests have shown that the friction coefficient or K factor of ventilation ducts made from the kit in accordance with the present invention is generally in the range of 2.25 to 2.5, as opposed to K factors of 9 for steel ducts or 7 for fibreglass ducts. These lower friction coefficients in the ducts result in energy savings as fewer or less power-consuming ventilation systems are required to displace a same amount of air through the ducts.

In addition to the main duct elements, several other ventilation accessories are available to interface with the ductwork elements built according to the present invention. These accessories include, among others: nozzles, guillotine valves, standard and demountable junction collets, T and Y couplings, 22.5, 45 or 90 degrees elbows, and reinforced pipes.

Of course, other types of accessories that can be made or sized to be compatible with the ductwork elements according to the present invention may also be provided.

Using the kit according to the present invention, approximately 120 feet of ductwork can be installed in a day. Moreover, typically the equivalent 800 to 1000 feet of ductwork can be carried in a single trailer, which facilitates transportation of the materials to installation sites.

Although preferred embodiments of the present invention have been described in detailed herein and illustrated in the accompanying drawings, it is to be understood that the invention is not limited to these precise embodiments and that various changes and modifications may be effected therein without departing from the scope or spirit of the present invention.

1. A coupling for a ventilation duct assembly for use with interconnecting ventilation duct elements comprising:
a first ventilation duct element comprised of a flexible panel wherein the flexible panel comprises:
first and second opposite duct-forming sides;
first and second opposite interconnecting sides for interconnection to a subsequent panel formed into a ductwork element; and
a connector for connecting the duct-forming sides together upon shaping of the ductwork element and wherein the panel is shaped into a first ductwork element with a male end smaller in diameter than a female end;
a second ventilation duct element comprised of a flexible panel wherein the flexible panel comprises:
first and second opposite duct-forming sides;
first and second opposite interconnecting sides for interconnection to a subsequent panel formed into a ductwork element; and
a connector for connecting the duct-forming sides together upon shaping of the ductwork element and wherein the panel is shaped into a second ductwork element with a male end smaller in diameter than the female end;
at least one C-shaped collet shaped to fit over the connected male and female ends of the formed ductwork elements for interconnection of adjacent shaped ductwork elements; and
at least one fastener for fastening the collet around the shaped ductwork elements, and linking extremities of the C-shaped collet together.

2. The coupling according to claim 1, wherein the connector comprises a male interlocking interface, a corresponding female interlocking interface respectively fixed on the first and second opposite duct-forming sides and interlockable together and a slideable locking element fitting over assembled male and female interlocking interfaces.

3. The coupling according to claim 2, wherein the collet is sized to extend between adjacent slideable locking elements from corresponding adjacent shaped ductwork elements.

4. The coupling according to claim 1, wherein the connector is at least one of a weld, an adhesive and an adhesive strip.

5. The coupling according to claim 1, wherein the collet comprises a collet strip and first and second opposite brackets at opposite extremities of the collet strip, and wherein the at least one fastener is a bracket fastener for fastening the first and second opposite brackets together.

6. The coupling according to claim 5, wherein a length of the collet strip is shorter than an external diameter of connected male and female ends of the formed ductwork elements and the bracket fastener is of sufficient length to connect the separated first and second opposite brackets upon installation of the collet on the connected male and female ends of the formed ductwork elements.

7. The coupling according to claim 5, wherein the collet strip is made of the same material as the flexible panels forming the ductwork elements.

8. The coupling according to claim 5, wherein the first and second opposite brackets are metallic.

9. The coupling according to claim 1, wherein each of the flexible panels comprises an abutment for restricting movement of the female end over the male end of an adjacent ductwork element.

10. A C-shaped collet shaped to fit over connected male and female ends of formed ductwork elements for interconnection of adjacent shaped ductwork elements, the C-shaped collet comprising:
a collet strip;
first and second opposite brackets at opposite extremities of the collet strip; and
at least one fastener for fastening the first and second opposite brackets together and maintaining an offset separation therebetween.

11. A method for assembling interconnecting ventilation ducts comprising the steps of:
a) inserting a female end of a formed ductwork element over a male end of an adjacent formed ductwork element;
b) inserting a C-shaped collet shaped to fit over the connected male and female ends of the formed ductwork elements, the C-shaped collet comprising:
a collet strip; and
first and second opposite brackets at opposite extremities of the collet strip,
and
c) fastening the first and second opposite brackets together and maintaining an offset separation therebetween, with at least one fastener.
